(19) United States
(12) Patent Application Publication
(10) Pub. No.: US 2007/0175075 A1
(43) Pub. Date: Aug. 2, 2007

(54) Permanently Mountable Frame Assembly For Interchangeable Sheet Media Display

(75) Inventor: Toni Sturdivant, Glendale, CA (US)

Correspondence Address: WALTER W. DUFT;LAW OFFICES OF WALTER W. DUFT, 8616 MAIN ST, SUITE 2, WILLIAMSVILLE, NY, 14221, US

(73) Assignee: WARNER ENTERTAINMENT, INC., Burbank, CA (US)

(21) Appl. No.: 11/548,602

(22) Filed: Oct. 11, 2006

Related U.S. Application Data
(60) Provisional application No. 60/726,104, filed on Oct. 12, 2005.

(51) Int. Cl. G09F 7/00

(52) U.S. Cl. 40/492

(57) ABSTRACT

A permanently mountable frame assembly for the display of interchangeable sheet media. According to an exemplary disclosed embodiment, the frame assembly may be constructed to include a back frame section adapted for rigid attachment to a surface, a front frame section adapted for removable securement to the back frame section, a transparent barrier on the front frame section, and a media-carrying region behind the barrier for receiving a sheet medium for display. The back frame section may be constructed with a substantially rectangular cross-sectional shape and may be sized to nest within the front frame section. The front frame section may be constructed with a decorative irregular cross-sectional shape and may be pivotally mounted to the back frame section. The transparent barrier may comprise a plastic sheet or other durable material. An optional security locking mechanism may be provided for locking the front frame section to the surface.

### CROSS-REFERENCE TO RELATED APPLICATIONS

This application claims the benefit of Provisional Patent Application Ser. No. 60/726,104, filed on Oct. 12, 2005.

### BACKGROUND OF THE INVENTION

1. Field of the Invention

The present invention relates to the field of graphical display, and more particularly to framing for the display of artwork in sheet media form.

2. Description of Prior Art

By way of background, sheet media artwork is conventionally displayed by individually framing the work and hanging it on wall or other surface for display. For certain types of sheet media, such as motion picture studio posters, individual framing can be costly because the artwork, if displayed in a movie theatre lobby or other venue for advertising and promotional purposes, is continually being replaced as new motion pictures are released. Even if the frames are reused, there is a cost associated with disassembling and reassembling the frames to replace the artwork. A further disadvantage of conventional framing is that the frames typically have glass faces, which presents a hazard during earthquakes or falls. A still further disadvantage of such framing is the cost of patching and painting walls or other surfaces as old artwork is removed and new artwork is added.

It is to improvements in artwork framing techniques that the present invention is directed. What is particularly needed is an improved frame design that is relatively low in cost, easy to install, relatively durable and shock resistant, and which preferably facilitates artwork exchange without frame duplication.

### SUMMARY OF THE INVENTION

The foregoing problems are solved and an advance in the art is achieved by a novel frame assembly for the display of interchangeable sheet media. The frame assembly includes a back frame section adapted for rigid attachment to a surface, a front frame section adapted for removable securement to the back frame section, a transparent barrier on the front frame section, and a media-carrying region behind the barrier for receiving a sheet medium for display. Advantageously, the sheet medium can be easily removed from the frame assembly and exchanged with another sheet medium by manipulating the front frame section while the back frame section remains rigidly attached to the surface.

In an illustrated exemplary embodiment of the frame assembly, the back frame section nests within the front frame section and includes mounting holes for receiving fasteners for attachment to the surface. The front frame section can be pivotally mounted to the back frame section, as by providing one or more bracket members on a top flange of the back frame section for engaging a corresponding number of blind apertures provided on a top flange of the front frame section. The back frame section may have a substantially rectangular cross-sectional shape and the front frame section may have a decorative irregular cross-sectional shape. Both frame sections may be constructed from wood, metal or other suitable material. The transparent barrier may comprise a plastic sheet or other durable material.

In a further aspect of the invention, a security locking mechanism may be provided for locking the front frame section to the surface. In the illustrated exemplary embodiment, the security locking mechanism includes a security clip on the front frame section and a security locking fastener adapted to engage the security clip and the surface when the front frame section is positioned for attachment to the surface (and in nested engagement with the back frame section). The security locking clip and the security locking fastener may be situated between the front frame section and the surface so as to be inaccessible except by way of a security tool that operates the security locking fastener. The security tool may be adapted for insertion between the front frame section and the surface and may include a key notch adapted to engage the security locking fastener. The security locking fastener may include a threaded stem for engaging the surface, a key-receiving shank for receiving the security tool, and a tabbed head member for engaging the security locking clip. The security clip may comprise a slot that receives the security locking fastener. The slot may be sized to receive the shank and to allow the tabbed head to pass therethrough in a first orientation while preventing the tabbed head from passing therethrough in a second orientation. The first and second orientations may be determined by a rotational position of the security locking fastener that is adjustable by way of the security tool.

### BRIEF DESCRIPTION OF THE DRAWINGS

The foregoing and other features and advantages of the invention will be apparent from the following more particular description of an exemplary embodiment of the invention, as illustrated in the accompanying Drawings in which:

FIG. 1 is a rear plan view showing a frame assembly constructed in accordance with the illustrated exemplary embodiment;

FIG. 1A is a front plan view showing the frame assembly of FIG. 1;

FIG. 2 is a front plan view showing a back frame section of the frame assembly of FIG. 1;

FIG. 3 is a front plan view showing a front frame section of the frame assembly of FIG. 1;

FIG. 4 is a cross-sectional view taken along line 4-4 in FIG. 1;

FIG. 5 is a cross-sectional view taken along line 5-5 in FIG. 1;

FIG. 6A is an enlarged plan view showing a security clip of the frame assembly of FIG. 1;

FIG. 6B is an enlarged plan view showing the security clip of FIG. 6A engaging a security locking fastener;

FIG. 7 is a plan view of the locking fastener of FIG. 6B; and

FIG. 8 is a plan view showing a security tool for operating the locking fastener of FIG. 6B.

### DETAILED DESCRIPTION OF EXEMPLARY EMBODIMENT

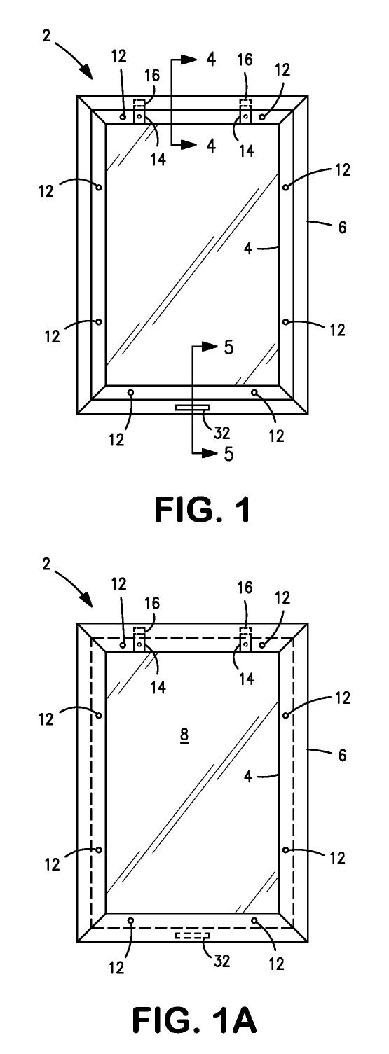

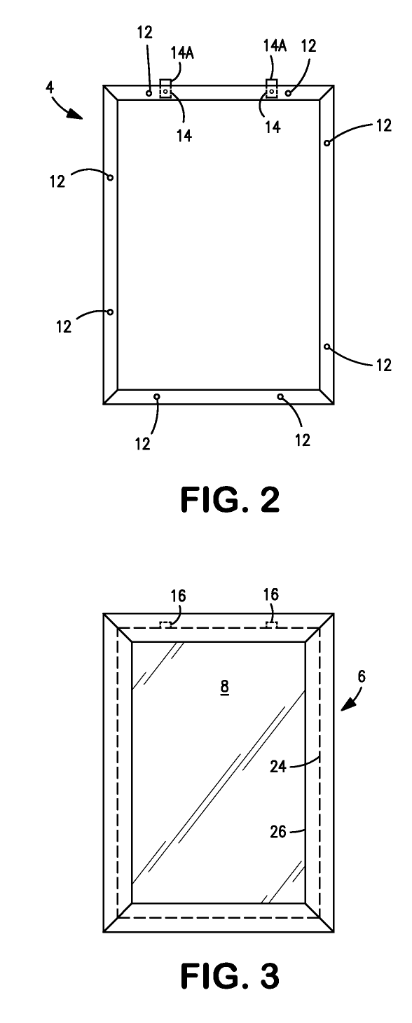

Turning now to the drawings wherein like reference numerals indicate like elements in all of the several views, FIGS. 1 and 1A are respective rear and front plan views of an exemplary frame assembly 2 for the display of interchangeable sheet media. As additionally shown in FIGS. 2 and 3, the frame assembly 2 includes a back frame section 4 (FIG. 2) adapted for rigid (and permanent) attachment to a surface S (such as a wall) (FIG. 5), a front frame section 6 (FIG. 3) adapted for removable securement to the back frame section, a transparent barrier 8 on the front frame section, and a media-carrying region 10 behind the barrier for receiving a sheet medium (not shown) for display. Advantageously, the sheet medium can be easily removed from the frame assembly and exchanged with another sheet medium by manipulating the front frame section 6 while the back frame section 4 remains rigidly attached to the surface S.

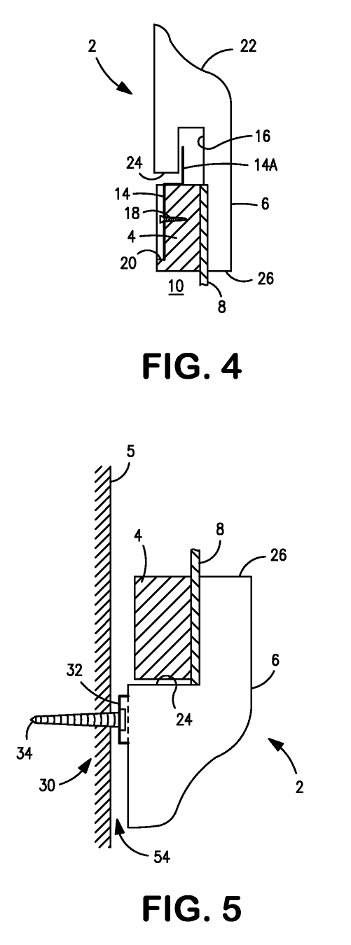

In the illustrated exemplary embodiment of FIGS. 1-3, the back frame section 4 nests within the front frame section 6 and includes mounting holes 12 for receiving fasteners (not shown) for attachment of the back frame section to the surface S. The front frame section 6 can be pivotally mounted to the back frame section 4, as by providing one or more bracket members 14 on a top flange of the back frame section for engaging a corresponding number of blind apertures 16 provided on a top flange of the front frame section. FIG. 4 illustrates this exemplary pivotally mounting construction. The bracket members 14 can be fabricated from metal or other suitable material. They may be mounted to back frame section 4 in any suitable manner, such by way of screw fasteners 18. A pair of mortises 20 may be optionally formed in the top flange of the back frame section 4 in order to recess the bracket members 14 and the fasteners 18 away from the surface S on which the frame assembly 2 is to be mounted. As shown in FIG. 4, the bracket members 14 may be suitably shaped, as by bending, to properly align upper portions 14A thereof within the blind apertures 16.

As also shown in FIG. 4, the back frame section 4 may have a substantially rectangular cross-sectional shape and the front frame section 6 may have a decorative irregular cross-sectional shape that may include a beveled edge 22. The rear face of the front frame section 6 is formed with an interior perimeter wall 24 that surrounds the outer edges of the back frame section 4. The front face of the front frame section 6 defines an inner peripheral lip 26 that extends inwardly from the perimeter wall 24 to capture the back frame section 4 and retain it in position. Both frame sections 4 and 6 may be constructed from wood, metal or other suitable material. The transparent barrier 8 may comprise a plastic sheet or other durable material.

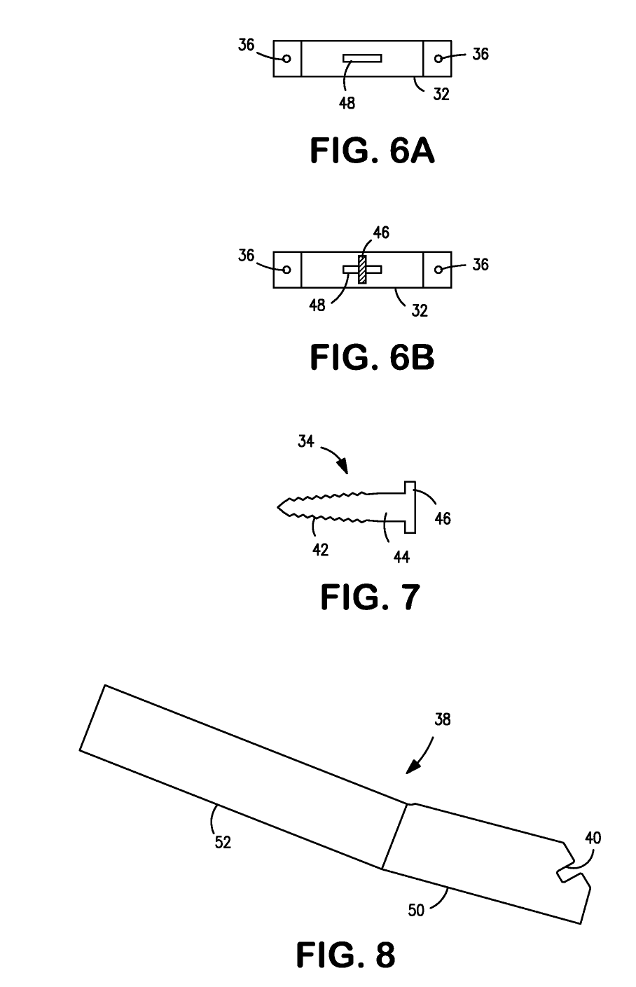

With additional reference now to FIGS. 5-8, a security locking mechanism 30 may be provided for locking the front frame section 6 to the surface S (e.g., the wall shown in FIG. 5). In the illustrated exemplary embodiment, the security locking mechanism 30 comprises a security clip 32 (FIGS. 1, 5, 6A and 6B) on the back of the front frame section 6 and a security locking fastener 34 (FIGS. 5 and 7) adapted to engage the security clip and the surface S when the front frame section is positioned for attachment to the surface S (and in nested engagement with the back frame section). As shown in FIG. 6A, the security locking clip 32 may be attached to the rear of the front frame section 6 using a pair of fasteners 36 or in any other suitable manner. The security locking clip 32 and the security locking fastener 34 may be situated between the front frame section 6 and the surface S. Preferably, these components will be inaccessible when the front frame section 6 is positioned for attachment to the surface S except by way of a security device, such as the security tool 38 shown in FIG. 8, that operates the security locking fastener 34.

The security tool 38 may be adapted for insertion between the front frame section 6 and the surface S and may include a key notch 40 adapted to engage the security locking fastener 34. As shown in FIG. 7, the security locking fastener 34 may include a threaded stem 42 for engaging the surface S, a key-receiving shank 44 for receiving the security tool 38, and a tabbed head member 46 for engaging the security locking clip 32. The shank 44 is preferably shaped (e.g., rectangular) so that it can be received and rotatably engaged by the key notch 40 of the security tool 38. The security clip 32 may comprise a slot 48 that receives the security locking fastener 34 (FIGS. 6A-6B). The slot 48 may be sized to receive the shank 44 and to allow the tabbed head 46 to pass therethrough in a first orientation (FIG. 6A) while preventing the tabbed head from passing therethrough in a second orientation (FIG. 6B). As can be seen in FIG. 5, the security clip 32 may be formed (as by bending) so that the slot 48 is spaced from the front frame section 6 in order to accommodate the security fastener's tabbed head 46. The first and second orientations of the tabbed head 46 may be determined by a rotational position of the security locking fastener 34 that is adjustable by way of the security tool 38. The security tool 38 may be formed with a stem 50 and a handle 52 that may be bent out of the plane of the stem. In order to rotate the security locking fastener 34, the security tool 38 may be inserted into the gap 54 (FIG. 5) that exists between the surface S and the bottom flange of the front frame section 6. With the stem 50 of the security tool 38 preferably be parallel to the surface S, the security tool may be advanced until the key notch 40 engages the shank 44 of the security fastener 34. The security tool handle 52 may then be manipulated to achieve the desired rotation of the security fastener 34.

In order to use the frame assembly 2, the back frame section 4 is first mounted to the surface S using suitable fasteners (such as screws) inserted through the mounting holes 12. As shown in FIG. 5, the back frame section 4 may be spaced from the surface S, as by placing washers on the fasteners used for mounting, or other spacing members. Alternatively, the back frame section 4 could be mounted flush to the surface S. With the back frame section 4 secured in position, the security fastener 34 may be inserted into the surface S at a location that will align with the slot 48 of the security clip 32 once the front frame section 6 is mounted. A sheet medium to be displayed may now be placed into the media carrying region 10. This will be the space defined by the back frame section's peripheral flanges, with rear support being available from the surface S. Alternatively, the back frame section could be provided with its own rear panel (not shown) for supporting the sheet medium. Once the sheet medium is properly positioned, the front frame section 6 is mounted to the rear frame section 4. This may be done by tilting the front frame section 6 so that its top flange is adjacent to the surface S and its bottom flange is spaced from the surface. After aligning the front frame section's blind apertures 16 with the rear frame section's bracket member portions 14A, the front frame section may be lowered to advance the bracket members into the blind apertures. The bottom flange of the front frame section 6 may then be pushed toward the surface S until the front frame section is oriented vertically and the back frame section 4 is fully nested therein. The front frame section 6 may now be secured to the surface S using the security locking mechanism 30. The security fastener 34 may thus be rotated into engagement with the security clip 32 using the security tool 38 in the manner described above.

With the front frame section 6 secured to the back frame section 4, it will be very difficult for unauthorized persons to remove the sheet medium. Without the security tool 38, this could only be accomplished by vandalizing the frame assembly 2 (e.g., breaking the transparent barrier 8), which would be impractical in a venue such as a movie theatre where the vandalism could be easily observed. For authorized personnel, the sheet medium can be easily replaced using the security tool 38 to disengage the security fastener 34 and manipulate the front frame section 6 to gain access to the media carrying region 10.

Accordingly, a frame assembly for displaying interchangeable sheet media has been disclosed. It should, of course, be understood that the description and the drawings herein are merely illustrative, and it will be apparent that various modifications, combinations and changes can be made in accordance with the invention. For example, although the mounting brackets 14 are mounted on the top flange of the back frame section 4, they could be alternatively mounted on a side flange or the bottom flange of the back frame section. Similarly, the locking mechanism 30 could be mounted at alternative locations on the front frame section 6, such as the top flange or side flanges thereof. A further alternative construction could dispense with the mounting brackets 14 and use a plural (two or more) locking mechanisms suitably positioned around the periphery of the front frame section 6 (e.g., top and bottom or right side and left side). As such, the invention is not to be in any way limited except in accordance with the spirit of the appended claims and their equivalents.

What is claimed is:

1. A frame assembly for the display of interchangeable sheet media, comprising:
a back frame section adapted for rigid attachment to a surface;
a front frame section adapted for removable securement to said back frame section;
a transparent barrier on said front frame section; and
a media-carrying region behind said barrier for receiving a sheet medium for display;
whereby said sheet medium can be removed from said frame assembly and exchanged with another sheet medium by manipulating said front frame section while said back frame section remains rigidly attached to said surface.

2. A frame assembly in accordance with claim 1, wherein said back frame section nests within said front frame section.

3. A frame assembly in accordance with claim 1, wherein said back frame section comprises mounting holes for receiving fasteners for attachment of said back frame section to said surface.

4. A frame assembly in accordance with claim 1, wherein said front frame section is pivotally mounted to said back frame section.

5. A frame assembly in accordance with claim 4, wherein said pivotal mounting is provided by one or more bracket members on a flange of said back frame section engaging a corresponding number of blind apertures on a flange of said front frame section.

6. A frame assembly in accordance with claim 5, wherein said bracket members are on a top flange of said back frame section and said blind apertures are on a top flange of said front frame section.

7. A frame assembly in accordance with claim 1, wherein said transparent barrier comprises plastic sheet material.

8. A frame assembly in accordance with claim 1, further including a security locking mechanism for removable attachment of said front frame section to said surface.

9. A frame assembly in accordance with claim 7, wherein said security locking mechanism comprises a security clip on said front frame section and a security locking fastener adapted to engage said security clip and said surface when said front frame section is positioned for attachment to said surface.

10. A frame assembly in accordance with claim 9, wherein said security locking clip and said security locking fastener are situated between said front frame section and said surface so as to be inaccessible when said front frame section is positioned for attachment to said surface except by way of a security tool that operates said security locking fastener.

11. A frame assembly in accordance with claim 10, wherein said security tool is adapted for insertion between said back frame section and said surface and includes a key notch adapted to engage said security locking fastener.

12. A frame assembly in accordance with claim 11, wherein said security locking fastener comprises a threaded stem for engaging said surface, a key-receiving shank for receiving said security tool, and a tabbed head member for engaging said security locking clip.

13. A frame assembly in accordance with claim 12, wherein said security clip comprises a slot that receives said security locking fastener, said slot being sized to receive said shank and to allow said tabbed head to pass therethrough in a first orientation while preventing said tabbed head from passing therethrough in a second orientation.

14. A frame assembly in accordance with claim 13, wherein said first and second orientations are determined by a rotational position of said security locking fastener.

15. A frame assembly in accordance with claim 14, wherein said rotational position of said security locking fastener is adjustable by way of said security tool.

16. A frame assembly in accordance with claim 15, wherein said security clip is mounted on a bottom flange of said front frame section.

17. A frame assembly in accordance with claim 1, wherein said back frame section has a substantially rectangular cross-sectional shape and said front frame section has a decorative irregular cross-sectional shape.

18. A frame assembly in accordance with claim 1, wherein said front frame section comprises an inner peripheral lip that captures said back frame section.

19. A method for displaying sheet media, comprising:
permanently attaching a back frame section to a surface;
selecting a front frame section having a transparent barrier;
placing a sheet medium so that it will be behind said transparent barrier; and
removably securing said front frame section to said back frame section.

20. A frame assembly for the display of interchangeable sheet media, comprising:
a back frame section adapted for rigid attachment to a surface;
a front frame section adapted for removable securement to said back frame section;
a transparent barrier on said front frame section;
a media-carrying region behind said barrier for receiving a sheet medium for display;
said back frame section nesting within said front frame section and comprising mounting holes for receiving fasteners for attachment of said back frame section to said surface;
said securement of said front frame section being provided by one or more bracket members on a flange of said back frame section engaging a corresponding number of blind apertures on a flange of said front frame section;
a security locking mechanism for removable attachment of said front frame section to said surface;
said security locking mechanism comprising a security clip on said front frame section and a security locking fastener adapted to engage said security clip and said surface when said front frame section is positioned for attachment to said surface;
said security locking clip and said security locking fastener being situated between said front frame section and said surface so as to be inaccessible when said front frame section is positioned for attachment to said surface except by way of a security tool that operates said security locking fastener;
said security tool being adapted for insertion between said back frame section and said surface and including a key notch adapted to engage said security locking fastener;
said security locking fastener comprising a threaded stem for engaging said surface, a key-receiving shank for receiving said security tool, and a tabbed head member for engaging said security locking clip;
security clip comprising a slot that receives said security locking fastener, said slot being sized to receive said shank and to allow said tabbed head to pass therethrough in a first orientation while preventing said tabbed head from passing therethrough in a second orientation;
said first and second orientations being determined by a rotational position of said security locking fastener;
said rotational position of said security locking fastener being adjustable by way of said security tool; and
said back frame section having a substantially rectangular cross-sectional shape and said front frame section having a decorative irregular cross-sectional shape;
whereby said sheet medium can be removed from said frame assembly and exchanged with another sheet medium by manipulating said front frame section while said back frame section remains rigidly attached to said surface.
